(19) United States
(12) Patent Application Publication
(10) Pub. No.: US 2014/0084089 A1
(43) Pub. Date: Mar. 27, 2014

(54) Labels Having an Information Dye

(71) Applicant: Avery Demmison Corporation, Pasadena, CA (US)

(72) Inventors: Thomas LANEY, Spencerport, NY (US); Wen-Li A. CHEN, Rochester, NY (US); Chieh-Wen CHEN, Willoughby Hills, OH (US)

(73) Assignee: Avery Demmison Corporation, Pasadena, CA (US)

(21) Appl. No.: 13/910,719

(22) Filed: Jun. 5, 2013

Related U.S. Application Data
(60) Provisional application No. 61/655,596, filed on Jun. 5, 2012.

(51) Int. Cl. G09F 3/02; G01N 21/59; B07C 5/34; B02C 23/08; G09F 3/04

(52) U.S. Cl. CPC G09F 3/02; B02C 23/08; G09F 3/04; B07C 5/34; G01N 21/59
USPC 241/20; 40/299.01; 40/310; 209/576; 356/432; 356/51; 250/459.1

(57) ABSTRACT

The present invention is directed to labels having one or more information dyes and methods for their use.

### CROSS-REFERENCE TO RELATED APPLICATION

The present application claims the benefit of U.S. Provisional Application No. 61/655,596 filed Jun. 5, 2012, which is incorporated herein by reference in its entirety.

### BACKGROUND

Labels, such as for use on product containers, are generally known in the art. In some instances, labels may be used to provide information about, or ornamentation to, an article to which it is applied.

### SUMMARY

The present invention provides for novel and useful labels. In one embodiment, the present invention includes a label having an information dye. In another embodiment, the present invention includes a label having an information dye wherein the label has a density of less than 1.0 gram per cubic centimeter. In yet another embodiment, the present invention includes a label coding system having a label with an information dye and also having an index correlating the information dye to particular information that it represents.

In another embodiment, the present invention is also directed to recycling methods. An exemplary method of the present invention includes a method for sorting items in a recycling process, wherein the method comprises irradiating an item presented for recycling item with electromagnetic radiation, wherein the item has a label affixed thereto and the label comprises an information dye that is representative of at least one material in the item. The method further includes detecting the absorption characteristic of the information dye in response to irradiation and identifying the presence of the information dye based upon the detected absorption. In another embodiment, the method may also include selecting an item for inclusion or exclusion in a recycling process based upon the detection of at least one predetermined information dye.

### BRIEF DESCRIPTION OF THE DRAWING

A full and enabling disclosure of the present invention directed to one of ordinary skill in the art, including any known best mode thereof, is set forth in the specification, which makes reference to the appended FIGURE, in which:

FIG. 1 is a schematic depiction of an exemplary recycling process.

### DETAILED DESCRIPTION OF THE EXEMPLARY EMBODIMENTS

Reference will now be made in detail to exemplary embodiments of the invention. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

As used herein, “information dye” means an ink or other solution that is detectable by a detection device and that indicates designated information about the label or the underlying article to which the label is intended to be affixed, wherein the designated information is indicated based upon a pre-assigned correlation between the presence of the information dye and the designated information (and not due to the pattern of application of the information dye). In one embodiment, the present invention includes a label having an information dye that effectively serves as a code to signify information. The information dye is capable of detection and may convey information, such as information pertaining to the label, the object to which the label is applied, other information, or any combination thereof.

Labels of the present invention may generally include any conventional label, such as labels applied to product containers and labels applied to products themselves. Such labels may be prepared using any conventional process, such as blown-film or cast-film extrusion or co-extrusion processes. For shrink labels, the extruded film is typically oriented in either machine direction, transverse direction, or both. In addition, labels of the present invention may be manufactured from any suitable material, and one of ordinary skill in the art will readily appreciate that the materials used in preparing the present labels may vary depending upon the desired characteristics and application of the label. By way of example, and without limitation, labels of the present invention may be manufactured using a polymeric material such as a polyester, polyolefin, polyvinyl chloride, polystyrene, polypropylene, and copolymers and/or blends thereof. Other label materials may include materials selected from polylactic acid, cellophane, styrenics, polylactic acid, polycarbonate, polyamides, polystyrene, mixtures and copolymers of any of the foregoing. Labels of the present invention can be applied to containers comprising glass, polymers, metals, or any other suitable container material. An exemplary container may be polyester bottles. In particular embodiments, labels may be prepared using polyvinyl chloride (“PVC”), polyethylene terephtalate (“PET” and “PET LV”), polyolefin, oriented polystyrene (“OPS film”), polylactic acid (“PLA film”), polyolefins, or combinations thereof. In one embodiment, a label of the present invention may be made from polyethylene terephtalate glycol-modified (“PET-G”),

In some embodiments, labels of the present invention may be a shrink sleeve label (also referred to as a shrink fit or shrink label) or stretch sleeve label (also referred to as a stretch fit or stretch label), both of which, and their methods of manufacture, are known in the art. A shrink fit label may be in a state in which it is larger in size than an article to which it is to be applied, and the label is shrunk using heat or other means to provide a generally tight fit to the article, such as a bottle. A stretch fit label may be in a state in which it is smaller in size than an article to which it is to be applied, and the label is stretched onto the article to provide a generally tight fit. Various embodiments of stretch fit and shrink fit labels are known in the art and within the scope of the present invention. In some embodiments shrink fit and stretch fit labels, as well as any other labels of the present invention, may cover a majority of, or substantially all of, the underlying packaging or product. By way of example, a shrink fit or stretch fit label may cover substantially all of the sides of a bottle.

As indicated above, labels of the present invention may include one or more information dyes, and the information dyes may be used to convey information concerning a label or an object to which a label is affixed. Information dyes of the present invention may include an ink or other substance incorporated into the label that, upon detection, conveys certain predetermined information associated with that particular dye. In some embodiments of the present invention, information dyes may be any dye that is detectable using near-infrared, x-ray, fluorescence, or ultraviolet detection methods. In one embodiment, a dye that absorbs electromagnetic radiation in the near infrared region, such as from about 750 nm to about 2500 nm may be used as an information dye, including individually each intermittent wavelength therein. In some embodiments, an information dye that absorbs electromagnetic radiation within the range of about 760 nm to about 900 nm may be used. In other embodiments, an information dye that absorbs electromagnetic radiation having a wavelength within the range from about 800 nm to about 2500 nm may be used. In addition, an information dye may have an absorption characteristic at one or more particular wavelengths, such as a dominant absorption peak in an absorption spectrum. In still further embodiments, an information dye may also, or alternatively, absorb electromagnetic radiation in the ultraviolet range.

In some embodiments, an information dye that does not absorb any or a significant amount of electromagnetic radiation in the visible range, such as from about 390 nm to about 750 nm, may be used so that the information dye does not interfere with other aesthetic elements of the label or container. As used herein with respect to absorbance of electromagnetic radiation in the visible range, a significant amount means greater than about 10% absorbance. However, in other embodiments, the information dye itself may be used as an aesthetic feature such that an information dye that absorbs electromagnetic radiation in the visible range may be desired.

Embodiments of the present invention may also include an information dye that also, or alternatively, has a detectable fluorescence. In some embodiments, an information dye of the present invention may detectably fluoresce upon exposure to electromagnetic radiation in the near infrared range. In other embodiments, an information dye may detectably fluoresce upon exposure to electromagnetic radiation in the ultraviolet and/or visible range.

Information dyes may be incorporated into labels using any conventional techniques. In one embodiment, concentrated resin dyes may be used to manufacture labels having an information dye. By way of example, a concentrated resin dye may be combined with polyethylene resin pellets to form a mixture of dye and polyethylene. This mixture may then be extruded into a film during an extrusion process such that the desired amount of dye is present in the resulting film, and the incorporated dye may serve as an information dye. One of ordinary skill in the art will appreciate that the foregoing example is illustrative only, and any suitable method for incorporating a dye into a label is within the scope of the present invention. By way of further example, and without limitation, information dyes may be incorporated into labels using printing or coating, or information dyes may be incorporated into dyes used to print visible images on a label.

Any suitable information dye may be used within the scope of the present invention. By way of example, the following exemplary information dyes, which are available from Adam Gates & Company, LLC of Hillsborough N.J., may be used in some embodiments of the present invention. In addition, the absorptivity is listed for each exemplary dye, which is the relative amount of energy, per unit weight, absorbed at the listed wavelength of that particular dye.

| λ Max (nm) | Dye Name | Absorptivity | Description |
|---|---|---|---|
| 739 | IR Dye 5739 | 96.0 | Metal Dithiolene |
| 739 | 5739 | 96.0 | Platinum Dithiolene |
| 740 | IR Dye 9740 | 182 | Polycyanine |
| 772 | IR Dye 9772 | 303 | Polycyanine |
| 780 | IR Dye 7036 | 52.6 | Metal Dithiolene |
| 784 | IR Dye 9784 | 239 | Polycyanine |
| 785 | IR Dye 2630 | 50 | Metal Dithiolene |
| 798 | IR Dye 9798 | 157 | Polycyanine |
| 803 | IR Dye 5803 | 77.3 | Metal Dithiolene |
| 803 | 5803 | 77.3 | Platinum Dithiolene |
| 807 | IR Dye 9807 | 409 | Polycyanine |
| 858 | IR Dye 5630 | 57 | Metal Dithiolene |
| 859 | IR Dye 9859 | 53 | Metal Dithiolene |
| 905 | IR Dye 1420 | 64.8 | Tris Aminium |
| 923 | IR Dye 3138 | 54.8 | Metal Dithiolene |
| 953 | IR Dye 1421 | 27 | Tetrakis Aminium |
| 956 | IR Dye 1114 | 20 | Tetrakis Aminium |
| 967 | IR Dye 2067 | 71 | Tris Aminium |
| 973 | IR Dye 1410 | 72.8 | Tris Aminium |
| 977 | IR Dye 2066 | 82 | Tris Aminium |
| 990 | IR Dye 1310 | 60 | Tris Aminium |
| 995 | IR Dye 7164 | 61.3 | Tris Aminium |
| 1057 | IR Dye 1422 | 81.4 | Tetrakis Aminium |
| 1073 | IR Dye 1120 | 69 | Tetrakis Aminium |

An information dye in a label should generally be present in an amount that is detectable. By way of example, and without limitation, labels of the present invention may include information dyes in an amount of about 5 to 10,000 parts per billion, including each incremental value therein. In other exemplary embodiments, the information dye may constitute about 0.005 to about 0.05 percent of the weight of the resulting label, including each incremental value therein.

Labels of the present invention may have a single layer or multiple layers, and one or more information dyes may be distributed in one or more layers. For example, a label may have one or more information dyes in a single layer. In other embodiments, an information dye may be incorporated into more than one layer of a label, and in some embodiments an information dye may be incorporated into every layer of a label. In still other embodiments, some or all layers of a label may include distinct information dyes. In yet other embodiments, an information dye may be incorporated into the skin layer of a label, which is the outermost layer away from the layer that is directly affixed to an object, or an information dye may be incorporated into a layer near the outermost layer in other embodiments.

In some embodiments, an information dye may be incorporated in a manner or a pattern to facilitate or improve its detectability in the label. By way of example, an information dye may be incorporated into a portion of one or more layers of a label, such as in a grid pattern. In other embodiments, an information dye may be distributed throughout one or more entire layers of a label.

As indicated above, information dyes of the present invention may be detectable and used to signify information. For example, the presence of an information dye in label may indicate that the label is affixed to an object manufactured of a certain material. Therefore, upon detection of that particular information dye, the material of the underlying object can be determined. Thus, the information dyes of the present invention may function as codes to signify information, and an index may be prepared that correlates particular information to a particular information dye.

In one embodiment, the coding function of labels having information dyes may be useful in recycling processes. For example, articles presented for recycling may be intermixed, and conventional sorting operations may irradiate an article and detect the article's absorption characteristics. Those detected absorption characteristics can be compared with known absorption characteristics for the articles that are to be included within the recycling process to identify materials for inclusion in a given recycling process. However, in some circumstances an article presented for recycling may be covered with a label such that the underlying article cannot be effectively irradiated. In such circumstances, an information dye of the present invention may be used in a label to signify the material of the underlying article.

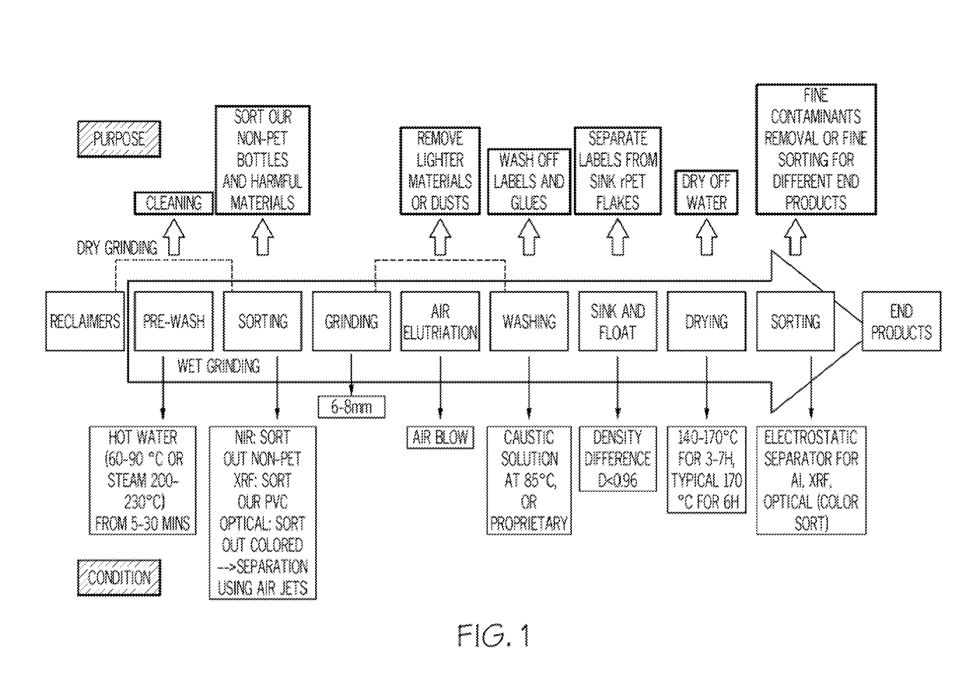

For illustrative purposes of this utility, a process for recycling PET material is schematically shown in FIG. 1. As shown, PET bottles are first subjected to a pre-wash. During this stage, the materials are cleaned and certain labels may be removed from the materials. In some embodiments, the pre-wash step may include introducing the materials to hot water of about 60-90° C. or hot steam of about 200-230° C. for about 5 to about 30 minutes.

After the pre-washing has taken place, the exemplary process then includes the step of sorting the materials. During this step, PET bottles are separated from other non-PET materials, and the sorted PET materials continue in the recycling process. By way of example, the materials presented for recycling can be irradiated with electromagnetic radiation in the near-infrared range. Upon reflection of the radiation from the materials, the detection of the radiation can be measured and compared to known values for certain materials. Because the absorption of PET is known, materials having PET in the illustrative process of FIG. 1 can effectively be separated from non-PET materials based upon the detected absorptions. In this manner, materials can also be sorted by color. In other embodiments, other sorting techniques, such as x-ray fluorescence, may also, or alternatively, be employed. After materials are identified, air jets may be used to separate any PET materials and non-PET materials such that only PET materials are subjected to the remaining recycling steps.

As provided above, a novel use of the present invention includes the use of labels having an information dye to identify materials during the sorting stage of a recycling process. For example, an information dye may be detected in a label using the conventional sorting technique described above in which a near-infrared detection device is used. Upon detection of a label, the information dye may signify the material that the underlying object is constructed of a certain material, thereby permitting sorting of the material for recycling. The information dye is particularly useful in circumstances in which a label covers all or a significant portion of the underlying material such that the underlying material cannot be effectively irradiated during the sorting operation, especially if the label was not effectively removed during a pre-wash process.

After sorting, materials selected for recycling, such as PET materials in FIG. 1, may be ground into pieces and subjected to air elutriation in order to remove any lighter materials or dust. Although applications may vary, the ground pieces may measure from about 6 to about 8 millimeters in some embodiments. In addition, the ground materials may be washed, such as in a caustic solution at about 85° C., and this washing may remove any remaining labels or adhesives.

The ground pieces may be further separated by density. In particular, ground material having a density greater than the water or tank solution will sink to the bottom of the tank, and any material less dense than the water or tank solution, such as certain label materials, will float to the top of the tank. In this manner, PET bottle material, which has a density of about 1.33 to about 1.35 grams per cubic centimeter, will sink and may be isolated from other material, such as remaining label material, that has a lower density than the solution used in the separation process. This “sink and float” separation may occur in the caustic solution from the washing or in a separate tank.

Following the sink and float tank in the exemplary recycling process of FIG. 1, the ground PET material may be dried. In some embodiments, the drying may be conducted at temperatures of about 140 to about 170° C. for about 3 to about 7 hours. In one particular embodiment, drying may be conducted at 170° C. for six hours. After drying, a final sorting step may be conducted, such as to remove any fine contaminants or to separate the ground materials for different end products. This sorting may done using an electrostatic separator for x-ray fluorescence and/or optical separation (such as for additional color sorting).

One of ordinary skill in the art would readily appreciate that the recycling process shown in FIG. 1 and discussed herein is exemplary in nature and that other processes are within the scope of the present invention and enabled by the disclosure herein. In particular, certain steps may be added and/or omitted from the exemplary process, and the illustrative parameters could be varied based upon the specific requirements of a process and the available equipment.

By way of further illustration, the present invention may include a product container comprised of PET having a shrink label that covers substantially all of the sides of the container. In addition, the label further may include an information dye that does not absorb electromagnetic radiation in the visible range but that does absorb electromagnetic radiation within the near infrared range. Based upon an index, the information dye in the label serves to identify the container as PET, and labels having that particular information dye are only intended to be applied to objects manufactured of PET. In an additional embodiment, the foregoing label may have a density of less than 1.0 gram per cubic centimeter such that it can be separated from the PET material using a density separation in a recycling process.

In another exemplary embodiment of the present invention, a green-colored bottle made of PET may have a label that includes Dye 1, which absorbs electromagnetic radiation having of wavelengths at 800 nm, and that also includes Dye 2, which absorbs electromagnetic radiation having of wavelengths at 950 nm. A second bottle that is clear and made of PET may have a label having the same Dye 1 and also Dye 3, which absorbs electromagnetic radiation having of wavelengths at 1200 nm. Finally, a clear bottle made from high density polyethylene may have a label having Dye 3 and also Dye 4, which absorbs electromagnetic radiation having of wavelengths at 1400 nm. An index may be provided indicating that the detection of Dye 1 symbolizes that the bottle associated with the label is a PET material, that the detection of Dye 2 symbolizes that the bottle associated with the label is green in color, that the detection of Dye 3 symbolizes that the bottle associated with the label is clear or transparent, and that the detection of Dye 4 symbolizes that the material associated with the label is high density polyethylene. The index may be programmed into a processing system at a recycling center such that materials can be recognized and sorted when the information dye characteristics are detected.

One of ordinary skill in the art will appreciate from the foregoing disclosure that labels of the present invention may be used in connection with any type of container or other material, including, without limitation, bottles, boxes, cans, and other containers. Specific exemplary embodiments include, without limitation, food containers, beverage containers, and household cleaning product containers. In other embodiments, labels of the present invention may be applied to a product itself, such as a toy or sporting equipment, without any additional container. In addition, one of ordinary skill in the art will appreciate from this disclosure that the present invention may have uses beyond labels and may include additional embodiments, such as product packaging, and that information dyes may be substances or solutions than ink.

These and other modifications and variations to the present invention may be practiced by those of ordinary skill in the art without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

What is claimed is:

1. A label comprising an information dye.

2. The label of claim 1, wherein the information dye has an absorption characteristic in the range of about 750 nm to about 2500 nm.

3. The label of claim 2, wherein the information dye has an absorption characteristic within the range of about 760 nm to about 900 nm.

4. The label of claim 2, wherein any absorbance of the information dye within the visible spectrum is less than about 10%.

5. The label of claim 1, wherein the label has a density of less than 1 gram per cubic centimeter.

6. The label of claim 1, wherein the label is a shrink label.

7. The label of claim 1, wherein the label is a stretch label.

8. The label of claim 1, wherein the label is affixed to a bottle.

9. The label of claim 8, wherein the information dye indicates at least one material in the bottle composition.

10. The label of claim 9, wherein the label covers at least substantially all sides of the bottle.

11. The label of claim 1, further comprising a second information dye.

12. A method for sorting items in a recycling process, wherein the method comprises the steps of:
irradiating an item presented for recycling with electromagnetic radiation, wherein a label is affixed to the item and the label comprises an information dye that is representative of at least one material in the item,
detecting the absorption characteristic of the information dye in response to the irradiation, and
identifying the presence of the information dye based upon the detected absorption.

13. The method of claim 12, wherein the method further comprises determining if the composition of the material is included within predefined materials for inclusion in the recycling process based at least in part upon the detection of the information dye.

14. The method of claim 13, wherein the detection of the presence of a particular information dye is indicative of at least one material present in the item.

15. The method of claim 14, wherein the radiation includes wavelengths in one or more of the near infrared range and the ultraviolet range.

16. The method of claim 15, wherein the detection of the absorption characteristic is the detection of fluorescence.

17. The method of claim 15, wherein the information dye does not absorb electromagnetic radiation in the visible range.

18. The method of claim 12, wherein the item is a bottle comprised of polyethylene terephtalate.

19. The method of claim 12, further comprising the step of sorting an item for inclusion or exclusion in a recycling process based upon the presence or absence of one or more information dyes.

20. The method claim 15, wherein the label has a density of less than 1.0 gram per cubic centimeter.

21. The method of claim 12, further comprising grinding the item into pieces and placing the ground pieces into a solution for density separation.

22. The method of claim 15, wherein the label is a shrink label.

23. The method of claim 15, wherein the label is a stretch label.

24. A label coding system, the system comprising:
a label comprising an information dye, and
an index correlating the information dye to particular information that it represents.

25. The system of claim 24, wherein the index pairs an information dye with a material such that the detection of the information dye is indicative of the material upon which the label is affixed.

26. The system of claim 25, wherein the label has a density of less than 1.0 gram per cubic centimeter.
